(19) United States
(12) Patent Application Publication
(10) Pub. No.: US 2008/0086756 A1
(43) Pub. Date: Apr. 10, 2008

(54) Media selection triggered through broadcast data

(75) Inventors: Jonathan C. Kagle, Bellevue, WA (US); Holly H. Kemp, Medina, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/544,991

(22) Filed: Oct. 5, 2006

(51) Int. Cl. H04N 7/173; H04N 11/00; H04N 7/00

(52) U.S. Cl. 725/108; 725/105; 348/460

(57) ABSTRACT

An electronic device is configured to perform different actions (e.g. playing media content) for an alarm in response to a received broadcast signal. The broadcast data received by the device is used to determine what action to perform when the alarm is triggered. The action to be performed may change based on the received broadcast data. For example, different media content may be selected in response to the received broadcast data. The action may also relate to modifying the playback of the media content in response to the broadcast data. The device may also be configured to quantize values into ranges for selection of the appropriate media as well as modify playback of the media in response to the broadcast data.

### BACKGROUND

Many different electronic devices, such as alarm clocks and personal digital assistants, use alarms to inform a user of an event. Typically these devices play a sound, light up, or vibrate to indicate that the alarm is triggered. While some of these devices allow the user to program a different sound for an alarm, the sound for the alarm remains constant once set. As such, the alarms merely provide the user with information that some event is occurring.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An electronic device is configured to perform different actions (e.g. executing different media content) for an alarm that has been triggered in response to a received broadcast. The broadcast data received by the device is used to determine what action to perform when the alarm is triggered. In response to the determination, the device sets the current action for the alarm. For example, different media content may be selected in response to changing content received in the broadcast data. The action may also relate to modifying the playback of the media content in response to the changing broadcast data.

### BRIEF DESCRIPTION OF THE DRAWINGS

FIG. 1 illustrates an exemplary operating environment;

FIG. 2 shows an illustrative architecture for an electronic device;

FIG. 3 illustrates a process for maintaining an alert reference table;

FIG. 4 shows a process for selecting media content in response to a triggered alarm; and

FIG. 5 illustrates a system for delivering and configuring channel information to an electronic device.

### DETAILED DESCRIPTION

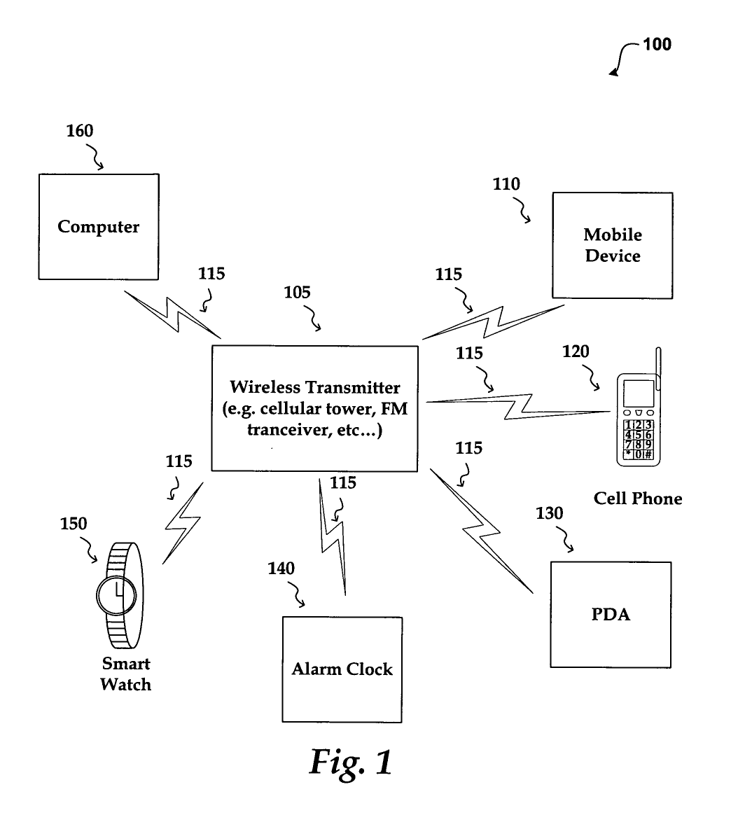

Referring now to the drawings, in which like numerals represent like elements, various embodiment will be described. In particular, FIG. 1 and the corresponding discussion are intended to provide a brief, general description of a suitable environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an example operating environment is described. As illustrated, operating environment 100 includes wireless transmitter 105 that is responsible for delivering broadcast content to wireless devices. Some example electronic devices that may include an electronic system arranged to operate according to the interaction model are illustrated in FIG. 1. Each of the electronic systems receives messages/information over the communication channel 115.

Generally described, an electronic device is configured to perform different actions for an alarm in response to a received broadcast signal. According to one embodiment, the action relates to executing media content that is selected in response to the changing broadcast data. For example, an alarm clock may be programmed to choose appropriate media content to reflect the current weather that is indicated in the received broadcast (e.g. a thunder sound for a heavy rain day, a rainfall sound for a light rain day, a birdsong for a sunny day, etc.). The action may also relate to modifying the playback of the media content in response to the broadcast data. For example, when an alarm is triggered on the device a horn sound could be rapidly played when traffic is heavy and slowly played when traffic is light. The device may also be configured to quantize values into ranges for selection of the appropriate media as well as modify playback of the media in response to the broadcast data. For example, the device could choose (or modify) a media playback based on a value included within the broadcast (e.g. choosing the right audio based on a range of temperature values, traffic conditions, and the like).

According to one embodiment, the wireless transmitter includes a cellular tower that may be used to communicate with a variety of electronic devices, including but not limited to: mobile devices 110; cell phones 120; personal digital assistants (PDAs) 130, alarm clocks 140; smart watches 150; as well as other computing devices. Some of the electronic devices could include devices such as notebooks, pocket PCs, tablet PCs, and the like.

According to another embodiment, the wireless transmitter 105 includes an FM transceiver that broadcasts signals over communication channel 115 to the various electronic devices. The FM broadcast may be any number of types including but not limited to: a standard FM transmission, a sub-carrier FM transmission, or any other type of FM transmission as may be desired. Example electronic devices that have an FM receiver or transceiver may include a computer 160, a watch 150, an alarm clock 140, a PDA 130, a cell phone 120, and mobile device 110. The electronic devices are arranged to receive information from the wireless broadcast.

According to one embodiment, each broadcast transmission corresponds to the transmission of one or more frames. Each frame may include multiple messages, where some messages are public broadcast (aka “global” or “shared” messages), while other messages are client specific messages (aka “personal” or “private” messages). Every client that is located within the designated service region may receive shared messages, while a single client may decode a private message.

Electronic devices (e.g., an alarm clock 140) receive message packets according to shared and private messages that are directed to the client device. According to one embodiment, message packets are organized in groups according to logical slot (or channel) entry numbers. For example, a particular electronic device is configured to receive a selected group of channels from the available channels. The message packets associated with each of those channels is received, processed, and stored in the client device. Some electronic devices allow the stored message packets to be reviewed using a user interface. Example channels that may be broadcast over communication channel 115 include: a traffic channel, a stocks channel, a news channel, a sports channel, a time channel, a messages channel, a calendar channel, a weather channel, a horoscope channel, and a movies channel. For example, the weather channel includes weather information for one or more cities and the news channel includes news stories from particular sources. Many other channels may be implemented. Messages associated with each channel are delivered to the electronic devices and include message content that is based on the particulars of the channel. Any number of these channels may be monitored by a device.

One or more of the electronic devices shown is configured to set and select media content in response to channel content that is received on the broadcast signal delivered through communication channel 115. For example, the media content for an alarm could be chosen based on a broadcast received by the device relating to weather information, traffic information, horoscope information, news information, sports information, as well as other information that may be contained within a broadcast. One example of this could be an alarm clock 140 that chooses an appropriate nature cue to reflect the current weather (e.g. thunder for a heavy rain day, rainfall for a light rain day, birdsongs for a sunny day, etc) that is reflected in the current broadcast data.

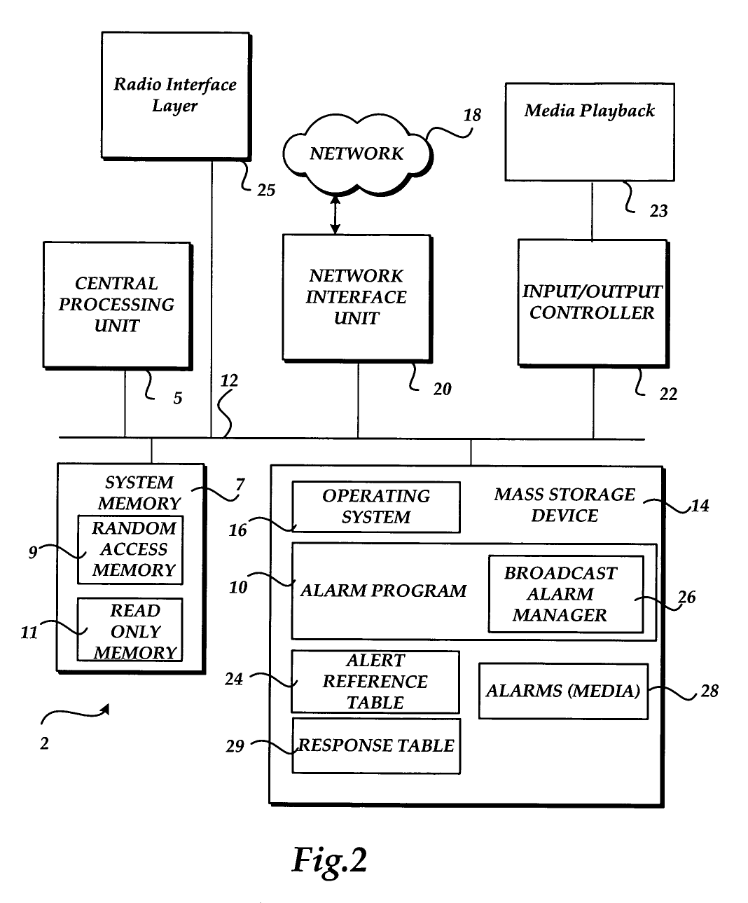

FIG. 2 shows an illustrative architecture for an electronic device 2 utilized in various embodiments. The computer architecture shown in FIG. 2 may include fewer components then illustrated or more components depending on the uses of the electronic device. As illustrated, electronic device 2 includes a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The electronic device 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the electronic device 2. Although the description of computer-readable media contained herein refers to a mass storage device, such as a hard disk or CD-ROM drive, the computer-readable media can be any available media that can be accessed by the electronic device 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the electronic device 2.

According to various embodiments of the invention, the electronic device 2 may operate in a networked environment using logical connections to remote computers through a network 18, such as the Internet. The electronic device 2 may connect to the network 18 through a network interface unit 20 connected to the bus 12. The network interface unit 20 may also be utilized to connect to other types of networks and remote computer systems. The electronic device 2 may also include an input/output controller 22 for receiving and processing input from a number of other devices, including a keyboard, mouse, or electronic stylus (not shown). Similarly, an input/output controller 22 may provide output to a media playback device 23, or other type of output device.

Electronic device 2 also includes a communication connection, such as radio interface layer 25, which performs the function of receiving and/or transmitting radio frequency communications. Radio interface layer 25 facilitates wireless connectivity for electronic device 2 and may be utilized to receive the broadcast data described herein. Transmissions to and from radio interface layer 25 are conducted under control of the operating system 16. In other words, communications received by radio interface layer 25 may be disseminated to application programs, such as alarm program 10.

As mentioned briefly above, a number of program modules and data files may be stored in the mass storage device 14 and RAM 9 of the electronic device 2, including an operating system 16 suitable for controlling the operation of an electronic device, such as an embedded operating system, a mobile operating system, or a desktop operating system. For example, the operating system could be the WINDOWS MOBILE operating system or the WINDOWS XP operating system from MICROSOFT CORPORATION of Redmond, Wash. The mass storage device 14 and RAM 9 may also store one or more program modules. In particular, the mass storage device 14 and the RAM 9 may store an alarm program 10. The alarm program 10 is operative to provide functionality for selecting and executing an action in response to a triggered alarm.

Broadcast alarm manager 26 is configured to select the action to execute in response to the changing broadcast data that is received by electronic device 2. According to one embodiment, the broadcast alarm manager 26 selects media content to play from alarms (media) store 28. Media store 28 may include many different types of media including, but not limited to: sound files, video files, and the like. According to one embodiment, when an alarm is triggered, broadcast alarm manager 26 executes the action that represents the most recently received content that is contained within the received broadcast data. While broadcast alarm manager 26 is shown as part of application 10, broadcast alarm manager 26 may be separate from application 10.

Alert reference table 24 contains a link to the action to perform in response to a specific alarm trigger. According to one embodiment, alert reference table 24 includes a link to media content to be played in response to a specific trigger. According to one embodiment, alert reference table 24 contains an alarm reference and an action reference. The action reference within alert reference table 24 is updated to reflect the most currently received broadcast data. For instance, if alarm reference's 1 action is currently set to play a light rain sound and the most recent broadcast content received indicates that it is raining harder, then the light rain sound action reference may be updated with a heavy rain sound action reference.

The following table illustrates an exemplary alert reference table 24.

| Trigger | Action |
|---|---|
| Alarm1 | LtRain.wav |
| Alarm2 | HvyTraffic.wav |
| MtgAlert | Shuffle.wav |
| StockAlert | PenniesFromHeaven.wma |

Response table 29 is utilized by broadcast alarm manager 26 to update the alarm action stored in the alert reference table 24 in response to the changing broadcast data. The following table illustrates an exemplary response table.

| Broadcast Value | Broadcast Value | | |
|---|---|---|---|
| (Low) | (High) | Action 1 | Action 2 |
| 0 | 3 | Thunder.wav | Stormyweather.mp3 |
| 4 | 5 | LtRain.wav | Waterfall.wav |
| 6 | 9 | Thrush.wav | Robin.wav |
| 10 | 12 | Wind.wav | Wind.wav |

The response table 29 may include more or fewer actions for each different alarm then illustrated. For example, one alarm could include two different actions while another alarm has one hundred different actions. As illustrated the response table 29 is a response table for weather actions that includes a first action (Action 1) for selection when a broadcast value relating to the value in the broadcast is at or closer to a low value and a second action (Action 2) when the broadcast value relating to the broadcast is at or closer to a high value. In the table illustrated, the values 0-3 illustrate strong weather, the values 4-5 illustrate rainy weather, the values 6-9 illustrate nice weather, and the values 10-12 illustrate windy weather. There are many different methods for determining a range of values or conditions. A numerical value may be assigned to the broadcast content (as illustrated), the broadcast itself could include the value or the action, and the like.

When an alarm is triggered (e.g. by a specific time stamp or an incoming phone call), the alarm program 10 accesses the alert reference table 24 to execute the correct alarm (e.g. playing raindrops, playing a horoscope, brewing an extra-strong pot of coffee, warming the car up, and the like).

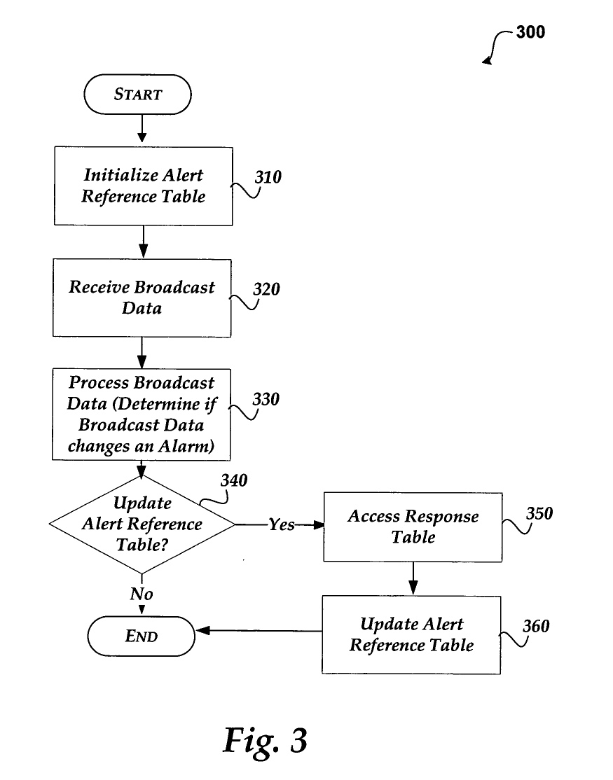

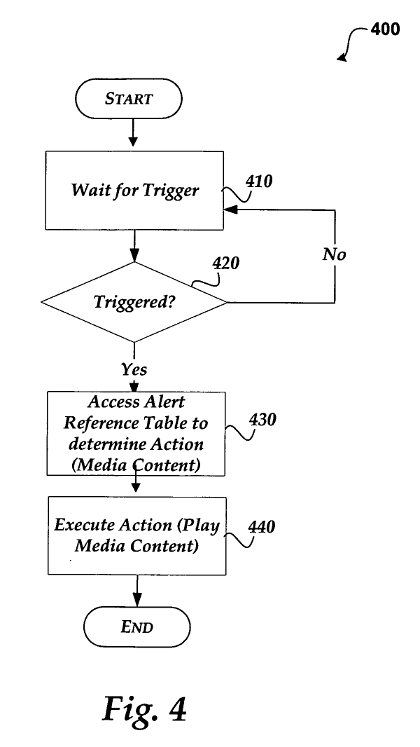

FIG. 3 illustrates a process for maintaining an alert reference table and FIG. 4 shows a process for selecting media content in response to a triggered alarm.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

Referring now to FIG. 3 a process for maintaining an alert reference table is illustrated.

After a start operation, the process flows to operation 310, where the alert reference table is initialized. According to one embodiment, default media content is associated with each of the alarms. For instance, initially all of the media content may be set to the media content that would typically be triggered for that alarm on an average day, week, month or year. For example, if alarm 1 played media content that related to broadcast weather and the device was located in Seattle, Wash. then a light rain sound may be a typical media content. If the device was in Hawaii, a light wind sound could be the default. Similarly, if an alarm is correlated to traffic content then the default in New York, N.Y. could be a heavy traffic sound, whereas in Spokane, Wash. the default could be a light traffic sound.

Flowing to operation 320, broadcast data is received by the device. As discussed above, the broadcast data may relate to many different topics such as weather, traffic, news, sports, and the like. According to one embodiment, a portion of the broadcast data is stored on the device. The broadcast data is received periodically throughout the day depending on the content of the channel. For example, traffic content may be broadcast more frequently during high traffic periods whereas weather content may be broadcast at a constant frequency.

At operation 330, the broadcast data is processed. Processing the broadcast data may include determining if the content of the broadcast data has changed enough to update the current media content for one or more of the alarms. According to one embodiment, a response table is accessed to determine whether or not the content of the broadcast has changed enough to change the action that is associated with the alarm. For example, if the weather was sunny before the last receipt of broadcast data and the current broadcast indicates that it is now raining then it is likely that the broadcast data has changed enough to change the action that is associated with an alarm. The media content may change as a result of small changes in the content, large changes in the content, or some change in the content that is between a small change and a large change. For example, one device may select between two different media content (e.g. hot/cold, traffic/no traffic) while another device may select between N different media content (e.g. 1-10, 1-100, and the like).

Moving to decision operation 340, a determination is made as to whether the alert reference table is to be updated in response to the received broadcast data. When the alert reference table is to be updated, then the process moves to operation 350.

At operation 350, the action selected from the response table in response to the broadcast data is accessed to determine what action (e.g. media content) to select to replace the current action in the alert reference table. According to one embodiment, the response table includes different actions for a range of values. According to another embodiment, the response table indicates a different speed to execute the action. For example, a horn sound could play faster when the traffic is heavy and play slower when the traffic is light.

Flowing to operation 360, the alert reference table is updated to reflect the most recently received broadcast data.

The process then moves to an end operation and returns to processing other actions.

FIG. 4 shows a process for selecting media content in response to a triggered alarm.

After a start operation the process flows to operation 410 where the device waits for an alarm to be triggered. The alarm may be triggered at a predetermined time, in response to an event (e.g. a phone call), or based on some other condition.

Flowing to decision block 420, a determination is made as to whether an alarm is triggered. When an alarm is not triggered, the process returns to block 410 to continue waiting for an alarm to be triggered. When an alarm is triggered, the process flows to operation 430.

At operation 430, the alert reference table is accessed to determine the action to execute in response to the triggered alarm. According to one embodiment, the action relates to playing media content. According to another embodiment, the action may relate to operating another device. For example, a car may be started and warmed up when the weather is determined to be cold from the broadcast data.

Moving to operation 440, the device executes the action as specified by the alert reference table.

The process then moves to an end operation and returns to processing other actions.

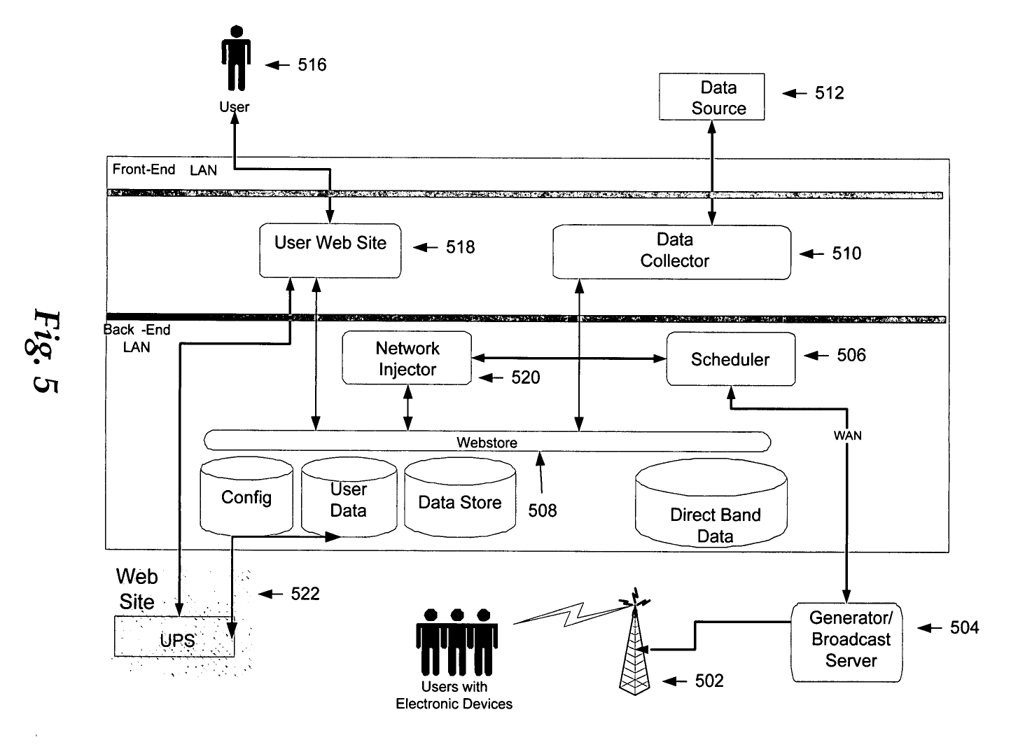

FIG. 5 illustrates a system for delivering and configuring channel information to an electronic device. According to one embodiment, predetermined channel information may be delivered to an electronic device. In this case, According to another embodiment, a user, such as user 516, may customize the channels they receive through user web site 518. Using website 518 the user may set options and select information associated with channels to which they have subscribed. For example, the user may configure the traffic information, weather information, and the like which are provided to the electronic device. The selected options are stored in a data store, such as webstore 508. Channel information and various options may also be automatically retrieved from a web site to which the user participates in. For example, web site 522 may be the user's home page in which the user has already selected various options customizing their page. These options may be used to populate the options associated with various channels. For example, a user's home location and work location could be used to calculate traffic information, a user's tracked stocks may be used in a stocks channel, a user's selected cities may be used in a weather channel, the user's selected theaters may be used in a movies channel, a user's news sources may be used in a news channel, and the like.

Data Collector 510 is configured to collect data from one or more data sources, such as data source 512, relating to a channel. For example, data collector 510 may retrieve traffic sensor data from one data source, incident reports from another data source, weather data from another source, and the like.

Data collector 510 may store the data in a data store, such as webstore 508, for later broadcast. According to one embodiment, data store 510 communicates with network injector 520 which then stores the data in webstore 508.

Broadcast transmitter tower 502 is arranged to provide a communication signal that is configured for reception by users with electronic devices that are located within a service region. Broadcast tower 502 transmits in response to generator/broadcast server 504. Generator 504 may communicate with scheduler 506 via a network communication link. Scheduler 506 is configured to schedule broadcast transmissions relating to channel information. The broadcast data may be broadcast according to a predetermined schedule. Some data may be broadcast more frequently during certain periods of the day (e.g. traffic data during rush hour). The device can also receive the broadcast data and determine how long the data is valid. This information may be included in the application on the device, or encoded in the data sent to the device. For example, traffic incident data may include an estimated completion time that may be used to remove the data, weather data could be valid for a day, and the like. This helps the device save resources by not having to repeatedly download the same data.

Selected services are entered in a database, such as webstore 508 for broadcast transmission at a later time. At the designated time (or time interval) scheduler 506 communicates with broadcast server 504 to begin a transmission sequence of data for the selected services. Broadcast server 504 converts the data to the appropriate format for transmission (i.e. an FM signal) and relays it to broadcast tower 502. In an alternative example, scheduler 506 communicates the selected services to the broadcast server. The broadcast server schedules the time interval for transmission of the selected service.

Each broadcast transmission corresponds to the transmission of one or more frames that are arranged in accordance with a frame protocol. Each frame may include multiple messages, where some messages are public broadcast (aka “global” or “shared” messages), while other messages are client specific messages (aka “personal” or “private” messages). Each frame includes a table of contents that indicates the extent of messages that are found within the next transmitted frame. Every client that is located within the designated service region receives the shared and personal messages. Personal messages, however, may only be decoded by a single client.

Each frame includes a header, a table of contents, and a message payload that includes the content for one or more selected services as previously described. The header also includes other information such as authentication data, identified service region, language, available stations for the identified service region, frame number, and time stamp. Control information may also be included in one of the headers to indicate broadcast conditions such as a change in available channels, an assignment of a service region to a particular wireless client device, and an assignment of a particular channel (frequency). In one example, each frame includes a change counter in one of the headers to indicate a change has taken place in the system. Wireless client devices (clients) may use the change counter to determine when to initiate a failover (when a broadcast tower becomes unavailable).

Client devices can determine the current service region based on information that is included in the broadcast transmissions. The time zone can be determined based on the current service region such that the client device can adjust any time related information. Moreover, the time and date functions of the client device may be synchronized based on information that is included in the broadcast transmissions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for performing an action in response to a triggered alarm on an electronic device, comprising:
receiving broadcast data; wherein the same broadcast data is broadcast to many electronic devices at the same time;
processing the broadcast data; wherein processing the broadcast data comprises determining whether the broadcast data has changed enough to perform an action when the alarm is triggered;
determining when the alarm is triggered; and
executing the action when the alarm is triggered.

2. The method of claim 1, wherein executing the action comprises playing a media content selection.

3. The method of claim 1, wherein determining whether the broadcast data has changed enough to perform the action comprises determining when a value associated with a most recently received broadcast data is outside of a value range that is associated with the action.

4. The method of claim 2, wherein determining whether the broadcast data has changed enough to perform the action comprises updating the action to perform within an alert reference table that includes a reference to the alarm and a reference to the action.

5. The method of claim 2, wherein determining whether the broadcast data has changed enough to perform the action comprises accessing a response table to determine when the action should be performed.

6. The method of claim 5, wherein accessing the response table to determine when the action should be performed comprises determining a value associated with the broadcast data and indexing the value in the response table to select the action.

7. The method of claim 2, wherein executing the action when the alarm is triggered comprises adjusting a playback of the media content.

8. The method of claim 7, wherein adjusting the playback of the media content comprises adjusting a speed of the playback.

9. The method of claim 2, wherein the broadcast data is received from an FM broadcast.

10. An apparatus for performing an action in response to a triggered alarm, comprising:
a data store that is configured to store media content;
a communication connection configured to receive broadcast data including channel content that is broadcast to a plurality of electronic devices at the same time and select a portion of the channel content based on a configuration of the electronic device to store in the data store;
a media playback device that is configured to play a media selection from the media content in response to the triggered alarm; and
an electronic system that is arranged to interact with the media playback device, the data store, the communication connection, wherein the electronic system is configured to:
updating the media selection in response to the received broadcast data;
determining when the alarm is triggered; and
instructing the media playback device to play the media selection when the alarm is triggered.

11. The apparatus of claim 10, wherein the electronic system is further configured to access a response table and compare a portion of the channel content to a value within the response table to determine whether to update the media selection.

12. The apparatus of claim 11, wherein updating the media selection comprises updating the media selection within an alert reference table that includes a reference to the alarm and a reference to the media selection.

13. The apparatus of claim 12, wherein instructing the media playback device to play the media selection when the alarm is triggered comprises adjusting a playback speed of the media selection.

14. The apparatus of claim 12, wherein the broadcast data is from an FM broadcast.

15. A computer-readable medium having computer executable instructions for performing an action in response to a triggered alarm, comprising:
receiving broadcast data; wherein the same broadcast data is broadcast to many electronic devices at the same time;
updating the action in response to changed content within the received broadcast;
determining when the alarm is triggered; and
executing the action when the alarm is triggered.

16. The computer-readable medium of claim 15, wherein executing the action comprises playing a media selection that corresponds to the action.

17. The computer-readable medium of claim 16, wherein updating the action in response to changed content within the received broadcast, comprises determining when a value contained within the broadcast data is outside of a value range that is currently associated with the action and when the value is outside of the value range updating the media selection.

18. The computer-readable medium of claim 17, wherein updating the action comprises accessing an alert reference table and updating a reference to the action within the alert reference table.

19. The computer-readable medium of claim 16, wherein playing the media selection comprises adjusting a playback speed of the media content.

20. The computer-readable medium of claim 16, wherein the broadcast data is received from an FM broadcast.
